(19) United States
(12) Patent Application Publication
(10) Pub. No.: US 2022/0366243 A1
(43) Pub. Date: Nov. 17, 2022

(54) APPARATUS AND METHOD FOR ENCODING MATRIX DATA

(71) Applicant: SAMSUNG SDS CO., LTD., Seoul (KR)

(72) Inventors: Yeong-Dae KWON, Seoul (KR); Jin-Ho CHOO, Seoul (KR); Il-Joo YOON, Seoul (KR); Min-Ah PARK, Seoul (KR); Du-Won PARK, Seoul (KR)

(21) Appl. No.: 17/741,553

(22) Filed: May 11, 2022

(30) Foreign Application Priority Data
May 13, 2021 (KR) 10-2021-0062091

(51) Int. Cl. G06N 3/08

(52) U.S. Cl. CPC G06N 3/08

(57) ABSTRACT

An apparatus for encoding matrix data according to an embodiment includes an initial encoding layer that outputs a plurality of encoded row vectors and a plurality of encoded column vectors for one or more pieces of matrix data representing information on a relationship between items having a plurality of characteristics based on the matrix data, a plurality of initial row vectors corresponding to the number of rows of the matrix data, and a plurality of initial column vectors corresponding to the number of columns of the matrix data, and one or more encoding layers that are disposed after the initial encoding layer and perform additional encoding on the plurality of encoded row vectors and the plurality of encoded column vectors.

### CROSS-REFERENCE TO RELATED APPLICATION(S)

This application claims the benefit under 35 USC § 119 of Korean Patent Application No. 10-2021-0062091, filed on May 13, 2021, in the Korean Intellectual Property Office, the entire disclosure of which is incorporated herein by reference for all purposes.

### BACKGROUND

### 1. Field of the Invention

Embodiments disclosed herein relate to a technology for encoding matrix data using a deep neural network.

### 2. Description of Related Art

Combinatorial optimization for finding a solution that best meets a given goal among combinations of given items plays an importance role in increasing efficiency across industries. In the existing field of operational research, research on various algorithms for combinatorial optimization has been conducted, and in these days, combinatorial optimization through artificial intelligence using a deep neural network is being attempted.

The general deep neural network uses data in a list form as an input, whereas data related to a significant number of combinatorial optimization problems are more suitable to be expressed in a matrix form rather than the list form. Typically, data in the form of a graph may be easily expressed in the form of an adjacency matrix.

In this case, in order to easily perform combinatorial optimization through the deep neural network, a neural network with a new structure that encodes data in the matrix form into a form to be used by the deep neural network is needed.

### SUMMARY

Embodiments disclosed herein are intended to provide means for encoding matrix data into a form to be used by a deep neural network in order to solve a problem in combinatorial optimization.

In one general aspect, there is provided an apparatus for encoding matrix data, including: an initial encoding layer that outputs a plurality of encoded row vectors and a plurality of encoded column vectors for one or more pieces of matrix data representing information on a relationship between items having a plurality of characteristics based on the matrix data, a plurality of initial row vectors corresponding to the number of rows of the matrix data, and a plurality of initial column vectors corresponding to the number of columns of the matrix data; and one or more encoding layers that are disposed after the initial encoding layer and perform additional encoding on the plurality of encoded row vectors and the plurality of encoded column vectors.

The one or more encoding layers may include a first type encoding layer that performs additional encoding using the matrix data, a plurality of row vectors output from an immediately preceding encoding layer, and a plurality of column vectors output from the immediately preceding encoding layer as inputs.

The one or more encoding layers may include a second type encoding layer that performs additional encoding using a plurality of row vectors output from an immediately preceding encoding layer and a plurality of column vectors output from the immediately preceding encoding layer as inputs.

The first type encoding layer may include a row encoding block that outputs a plurality of additionally encoded row vectors by receiving the matrix data, the plurality of row vectors output from the immediately preceding encoding layer, and the plurality of column vectors output from the immediately preceding encoding layer, and a column encoding block that outputs a plurality of additionally encoded column vectors by receiving transposed matrix data, the plurality of row vectors output from the immediately preceding encoding layer, and the plurality of column vectors output from the immediately preceding encoding layer.

The first type encoding layer may include a row encoding block that outputs a plurality of additionally encoded row vectors by receiving the matrix data, the plurality of row vectors output from the immediately preceding encoding layer, and the plurality of column vectors output from the immediately preceding encoding layer, and a column encoding block that outputs a plurality of additionally encoded column vectors by receiving transposed matrix data, the plurality of additionally encoded row vectors output from the row encoding block, and the plurality of column vectors output from the immediately preceding encoding layer.

The first type encoding layer may include a column encoding block that outputs a plurality of additionally encoded column vectors by receiving transposed matrix data, the plurality of row vectors output from the immediately preceding encoding layer, and the plurality of column vectors output from the immediately preceding encoding layer, and a row encoding block that outputs a plurality of additionally encoded row vectors by receiving the matrix data, the plurality of row vectors output from the immediately preceding encoding layer, and the plurality of additionally encoded column vectors output from the column encoding block.

The second type encoding layer may include a row encoding block that outputs a plurality of additionally encoded row vectors based on the plurality of row vectors output from the immediately preceding encoding layer and the plurality of column vectors output from the immediately preceding encoding layer, and a column encoding block that outputs a plurality of additionally encoded column vectors based on the plurality of row vectors output from the immediately preceding encoding layer and the plurality of column vectors output from the immediately preceding encoding layer.

The second type encoding layer may include a row encoding block that outputs a plurality of additionally encoded row vectors by receiving the plurality of row vectors output from the immediately preceding encoding layer and the plurality of column vectors output from the immediately preceding encoding layer, and a column encoding block that outputs a plurality of additionally encoded column vectors by receiving the plurality of additionally encoded row vectors output from the row encoding block, and the plurality of column vectors output from the immediately preceding encoding layer.

Meanwhile, the second type encoding layer may include a column encoding block that outputs a plurality of additionally encoded column vectors by receiving the plurality of row vectors output from the immediately preceding encoding layer and the plurality of column vectors output from the immediately preceding encoding layer, and a row encoding block that outputs a plurality of additionally encoded row vectors by receiving the plurality of row vectors output from the immediately preceding encoding layer and the plurality of additionally encoded column vectors output from the column encoding block.

The row encoding block may include a first row encoding sub-block that outputs first intermediate matrix data having the same dimension as the matrix data based on one or more preset functions using the plurality of received row vectors and the plurality of received column vectors as variables, a second row encoding sub-block that outputs second intermediate matrix data having the same dimension as the matrix data by performing element-wise operation on the matrix data and the first intermediate matrix data based on a learnable neural network, and a third row encoding sub-block that outputs the plurality of additionally encoded row vectors based on one or more preset functions using the second intermediate matrix data and the plurality of received column vectors as variables.

The column encoding block may include a first column encoding sub-block that outputs first intermediate matrix data having the same dimension as the matrix data based on one or more preset functions using the plurality of received row vectors and the plurality of received column vectors as variables, a second column encoding sub-block that outputs second intermediate matrix data having the same dimension as the matrix data by performing element-wise operation on the matrix data and the first intermediate matrix data based on a learnable neural network, and a third column encoding sub-block that outputs the plurality of additionally encoded column vectors based on one or more preset functions using the second intermediate matrix data and the plurality of received row vectors as variables.

Meanwhile, the row encoding block may include a first row encoding sub-block that outputs first intermediate matrix data having the same dimension as the matrix data based on one or more preset functions using the plurality of received row vectors and the plurality of received column vectors as variables, and a third row encoding sub-block that outputs the plurality of additionally encoded row vectors based on one or more preset functions using the first intermediate matrix data and the plurality of received column vectors as variables.

Meanwhile, the column encoding block may include a first column encoding sub-block that outputs first intermediate matrix data having the same dimension as the matrix data based on one or more preset functions using the plurality of received row vectors and the plurality of received column vectors as variables, and a third column encoding sub-block that outputs the plurality of additionally encoded column vectors based on one or more preset functions using the first intermediate matrix data and the plurality of received row vectors as variables.

The apparatus for encoding matrix data may further include an initial vector determiner that determines at least some of the plurality of initial row vectors and the plurality of initial column vectors based on at least one of a first technique for randomly selecting as many vectors as the number corresponding to the number of rows or columns of the matrix data from a list of a plurality of vectors prepared in advance and a second technique for randomly sorting as many vectors as the number corresponding to the number of rows or columns of the matrix data.

The plurality of initial row vectors or the plurality of initial column vectors may be zero vectors.

In another general aspect, there is provided a method for encoding matrix data, including: outputting a plurality of encoded row vectors and a plurality of encoded column vectors for one or more pieces of matrix data representing information on a relationship between items having a plurality of characteristics based on the matrix data, a plurality of initial row vectors corresponding to the number of rows of the matrix data, and a plurality of initial column vectors corresponding to the number of columns of the matrix data; and performing additional encoding on the plurality of encoded row vectors and the plurality of encoded column vectors.

The performing of the additional encoding may include performing first type encoding of performing additional encoding using the matrix data, a plurality of row vectors output from a result of performing immediately preceding encoding, and a plurality of column vectors output from the result of the performing of the immediately preceding encoding as inputs.

The performing of the additional encoding may include performing second type encoding of performing additional encoding using a plurality of row vectors output from a result of performing immediately preceding encoding, and a plurality of column vectors output from the result of the performing of the immediately preceding encoding as inputs.

The performing of the first type encoding may include performing row encoding of outputting a plurality of additionally encoded row vectors by receiving the matrix data, the plurality of row vectors output from the result of the performing of the immediately preceding encoding, and the plurality of column vectors output from the result of the performing of the immediately preceding encoding, and performing column encoding of outputting a plurality of additionally encoded column vectors by receiving transposed matrix data, the plurality of row vectors output from the result of the performing of the immediately preceding encoding, and the plurality of column vectors output from the result of the performing of the immediately preceding encoding.

Meanwhile, the performing of the first type encoding may include performing row encoding of outputting a plurality of additionally encoded row vectors by receiving the matrix data, the plurality of row vectors output from the result of the performing of the immediately preceding encoding, and the plurality of column vectors output from the result of the performing of the immediately preceding encoding, and performing column encoding of outputting a plurality of additionally encoded column vectors by receiving transposed matrix data, the plurality of additionally encoded row vectors output from the result of the performing of the row encoding, and the plurality of column vectors output from the result of the performing of the immediately preceding encoding.

The performing of the first type encoding may include performing column encoding of outputting a plurality of additionally encoded column vectors by receiving transposed matrix data, the plurality of row vectors output from the result of the performing of the immediately preceding encoding, and the plurality of column vectors output from the result of the performing of the immediately preceding encoding, and performing row encoding of outputting a plurality of additionally encoded row vectors by receiving the matrix data, the plurality of row vectors output from the result of the performing of the immediately preceding encoding, and the plurality of additionally encoded column vectors output from the result of the performing of the column encoding.

The performing of the second type encoding may include performing row encoding of outputting a plurality of additionally encoded row vectors based on the plurality of row vectors output from the result of the performing of the immediately preceding encoding and the plurality of column vectors output from the result of the performing of the immediately preceding encoding, and performing column encoding of outputting a plurality of additionally encoded column vectors based on the plurality of row vectors output from the result of the performing of the immediately preceding encoding, and the plurality of column vectors output from the result of the performing of the immediately preceding encoding.

Meanwhile, the performing of the second type encoding may include performing row encoding of outputting a plurality of additionally encoded row vectors by receiving the plurality of row vectors output from the result of the performing of the immediately preceding encoding and the plurality of column vectors output from the result of the performing of the immediately preceding encoding, and performing column encoding of outputting a plurality of additionally encoded column vectors by receiving the plurality of additionally encoded row vectors output from the result of the performing of the row encoding and the plurality of column vectors output from the result of the performing of the immediately preceding encoding.

The performing of the second type encoding may include performing column encoding of outputting a plurality of additionally encoded column vectors by receiving the plurality of row vectors output from the result of the performing of the immediately preceding encoding and the plurality of column vectors output from the result of the performing of the immediately preceding encoding, and performing row encoding of outputting a plurality of additionally encoded row vectors by receiving the plurality of row vectors output from the result of the performing of the immediately preceding encoding and the plurality of additionally encoded column vectors output from the result of the performing of the column encoding.

The performing of the row encoding may include performing first row sub encoding of outputting first intermediate matrix data having the same dimension as the matrix data based on one or more preset functions using the plurality of received row vectors and the plurality of received column vectors as variables, performing second row sub encoding of outputting second intermediate matrix data having the same dimension as the matrix data by performing element-wise operation on the matrix data and the first intermediate matrix data based on a learnable neural network, and performing third row sub encoding of outputting the plurality of additionally encoded row vectors based on one or more preset functions using the second intermediate matrix data and the plurality of received column vectors as variables.

The performing of the column encoding may include performing first column sub encoding of outputting first intermediate matrix data having the same dimension as the matrix data based on one or more preset functions using the plurality of received row vectors and the plurality of received column vectors as variables, performing second column sub encoding of outputting second intermediate matrix data having the same dimension as the matrix data by performing element-wise operation on the matrix data and the first intermediate matrix data based on a learnable neural network, and performing third column sub encoding of outputting the plurality of additionally encoded column vectors based on one or more preset functions using the second intermediate matrix data and the plurality of received row vectors as variables.

Meanwhile, the performing of the row encoding may include performing first row sub encoding of outputting first intermediate matrix data having the same dimension as the matrix data based on one or more preset functions using the plurality of received row vectors and the plurality of received column vectors as variables, and performing third row sub encoding of outputting the plurality of additionally encoded row vectors based on one or more preset functions using the first intermediate matrix data and the plurality of received column vectors as variables.

Meanwhile, the performing of the column encoding may include performing first column sub encoding of outputting first intermediate matrix data having the same dimension as the matrix data based on one or more preset functions using the plurality of received row vectors and the plurality of received column vectors as variables, and performing third column sub encoding of outputting the plurality of additionally encoded column vectors based on one or more preset functions using the first intermediate matrix data and the plurality of received row vectors as variables.

The method may further include determining at least some of the plurality of initial row vectors and the plurality of initial column vectors based on at least one of a first technique for randomly selecting as many vectors as the number corresponding to the number of rows or columns of the matrix data from a list of a plurality of vectors prepared in advance and a second technique for randomly sorting as many vectors as the number corresponding to the number of rows or columns of the matrix data.

The plurality of initial row vectors or the plurality of initial column vectors may be zero vectors.

### BRIEF DESCRIPTION OF THE DRAWINGS

FIG. 1 is a block diagram for illustrating an apparatus for encoding matrix data according to an embodiment.

FIG. 2 is a diagram schematically illustrating a matrix data encoding process according to a first embodiment.

FIG. 3 is a diagram schematically illustrating a matrix data encoding process according to a second embodiment.

FIGS. 4 to 6 are diagrams illustrating a matrix data encoding process performed in each of first type encoding layers.

FIGS. 7 to 9 are diagrams illustrating a matrix data encoding process performed in each of second type encoding layers.

FIG. 10 is a diagram illustrating a matrix data encoding process performed in each row encoding block in a first type encoding layer.

FIG. 11 is a diagram illustrating a matrix data encoding process performed in each column encoding block in a first type encoding layer.

FIG. 12 is a diagram illustrating a matrix data encoding process performed in each row encoding block in a second type encoding layer.

FIG. 13 is a diagram illustrating a matrix data encoding process performed in each column encoding block in a second type encoding layer.

FIG. 14 is a block diagram for illustrating an apparatus for encoding matrix data according to an additional embodiment.

FIG. 15 is a flowchart illustrating a method for encoding matrix data according to an embodiment.

FIG. 16 is a flowchart illustrating a method for encoding matrix data according to an additional embodiment.

FIG. 17 is a block diagram for illustrating an exemplary combinatorial optimization learning apparatus including an apparatus for encoding matrix data according to an embodiment.

FIG. 18 is a block diagram for illustrating an exemplary combinatorial optimization inference apparatus including an apparatus for encoding matrix data according to an embodiment.

FIG. 19 is a block diagram for exemplarily illustrating a computing environment including a computing device according to an embodiment.

### DETAILED DESCRIPTION

Hereinafter, specific embodiments will be described with reference to the accompanying drawings. The following detailed description is provided to assist in a comprehensive understanding of the methods, devices and/or systems described herein. However, the detailed description is only for illustrative purposes and the disclosed embodiments are not limited thereto.

In describing the embodiments, when it is determined that detailed descriptions of related known technology may unnecessarily obscure the gist of the disclosed embodiments, the detailed descriptions thereof will be omitted. The terms used below are defined in consideration of functions in the disclosed embodiments, but may be changed depending on the customary practice or the intention of a user or operator. Thus, the definitions should be determined based on the overall content of the present specification. The terms used herein are only for describing the embodiments, and should not be construed as limitative. Unless expressly used otherwise, a singular form includes a plural form. In the present description, the terms “including”, “comprising”, “having”, and the like are used to indicate certain characteristics, numbers, steps, operations, elements, and a portion or combination thereof, but should not be interpreted to preclude one or more other characteristics, numbers, steps, operations, elements, and a portion or combination thereof.

In the following description, the terminology “transmission”, “communication”, “reception” of a signal or information and terminology similar thereto may include a meaning in which the signal or information is directly transmitted from one element to another element and transmitted from one element to another element through an intervening element.

In particular, “transmission” or “sending” of the signal or information to one element may indicate a final destination of the signal or information and may not imply a direct destination. The same is true for “reception” of the signal or information. In addition, in the present specification, a meaning in which two or more pieces of data or information are “related” indicates that when any one piece of data (or information) is obtained, at least a portion of other data (or information) may be obtained based thereon.

Further, it will be understood that, although the terms first, second, etc. may be used herein to describe various elements, these elements should not be limited by these terms. These terms may be used to distinguish one element from another element.

For example, without departing from the scope of the present disclosure, a first element could be termed a second element, and similarly, a second element could be termed a first element.

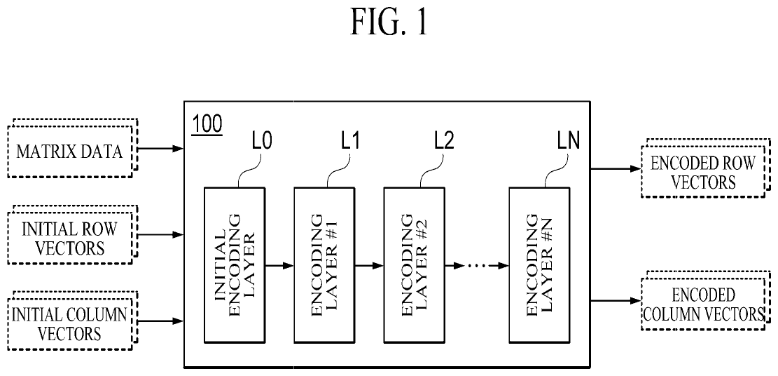

FIG. 1 is a block diagram for illustrating an apparatus 100 for encoding matrix data (matrix data encoding apparatus) according to an embodiment.

Referring to FIG. 1, the matrix data encoding apparatus 100 according to an embodiment includes an initial encoding layer L0 and one or more encoding layers L1, L2, . . . , LN. However, one or more encoding layers L1, L2, . . . , LN are for performing additional encoding and may be omitted in some embodiments. In other words, the matrix data encoding apparatus 100 disclosed herein may include only the initial encoding layer L0 as an encoding layer, or may further include an additional encoding layer in addition to the initial encoding layer L0.

In the illustrated embodiment, each component may have different functions and capabilities in addition to those described below, and additional components may be included in addition to those described below.

In addition, in an embodiment, each encoding layer may be implemented by using one or more physically separated devices, or may be implemented by one or more processors or a combination of one or more processors and software, and may not be clearly distinguished in specific operations, unlike the illustrated example.

The initial encoding layer L0 outputs a plurality of encoded row vectors and a plurality of encoded column vectors for one or more pieces of matrix data representing information on a relationship between items having a plurality of characteristics based on the matrix data, a plurality of initial row vectors corresponding to the number of rows of the matrix data, and a plurality of initial column vectors corresponding to the number of columns of the matrix data.

In the following embodiments, ‘matrix data’ means data representing a relationship between characteristics of items in a matrix when two or more characteristics exist between arbitrary items. In this case, ‘item’ means not only a tangible object such as automobiles, pencils, and fruits, but also an intangible object such as blood type and age, and ‘characteristics of an item’ mean not only the essential characteristic of each item, but also any property given by a user or a third party.

For example, when there are M items of type A and N items of type B, a relationship between the two types of items for one characteristic may be expressed as one piece of M*N matrix data, and a relationship for another characteristic may be expressed as another piece of M*N matrix data.

Considering the above, ‘encoding of matrix data’ means a process of converting a relationship between items based on each characteristic presented as ‘matrix data’ into a row vector representing as many items as the number of rows of ‘matrix data’ for each characteristic and a column vector representing as many items as the number of columns of ‘matrix data’ for each characteristic.

In addition, in the following embodiments, ‘initial row vectors’ and ‘initial column vectors’ are vectors composed of initial values set for encoding matrix data, and each of the ‘initial row vectors’ may have a dimension value corresponding to the number of rows of matrix data, and each of the ‘initial column vectors’ may have a dimension value corresponding to the number of columns of matrix data. Since each element value of the ‘initial row vector’ and the ‘initial column vector’ is used throughout the encoding process, a user of the matrix data encoding apparatus 100 may obtain various encoding results for matrix data by variously setting an ‘initial row vector’ and an ‘initial column vector’.

For example, each of a plurality of ‘initial row vectors’ and a plurality of ‘initial column vectors’ may be any one of a one-hot vector, a positional encoded vector based on a sin function, a positional encoded vector based on a cos function, and a zero vector. In particular, when a zero vector is used as a plurality of initial row vectors or a plurality of initial column vectors, the matrix data encoding apparatus 100 has an advantage that encoding may be performed without being constrained by the length of a row or column of matrix data, and in fact, the experimental results based on various matrix datasets support that the use of such a zero vector not only removes the constraints on encoding of matrix data, but also improves the performance of the encoding itself.

However, each of the plurality of ‘initial row vectors’ and the plurality of ‘initial column vectors’ may be generated by a pre-trained learning model. That is, element values of each of the ‘initial row vector’ and the ‘initial column vector’ may be a value set by a pre-trained learning model, and in this case, the learning model may be a model implemented using the matrix data encoding apparatus 100, but may be a model to be implemented using another computing device outside the matrix data encoding apparatus 100. In addition, the learning model may be an artificial intelligence (AI)-based model including deep learning, but is not necessarily limited thereto, and may be a model composed of one or more conditional statements in which a condition or a return value is changed according to learning.

Each of the encoding layers L1, L2, . . . , LN is disposed after the initial encoding layer L0 to perform additional encoding on the plurality of encoded row vectors and the plurality of encoded column vectors.

Specifically, the encoding layers L1, L2, LN are each sequentially disposed after the initial encoding layer L0 to receive a plurality of row vectors and a plurality of column vectors output from the immediately preceding encoding layer, and perform re-encoding on the plurality of received row vectors and the plurality of received column vectors. In this case, in general, the number of encoding layers added after the initial encoding layer L0 is proportional to the performance of the entire matrix data encoding apparatus 100.

According to an embodiment, the encoding layers L1, L2, LN may be each classified as a first type encoding layer and a second type encoding layer according to whether matrix data is used as input data.

Hereinafter, for convenience of description, an embodiment related to the first type encoding layer will be referred to as a first embodiment, and an embodiment related to the second type encoding layer will be referred to as a second embodiment.

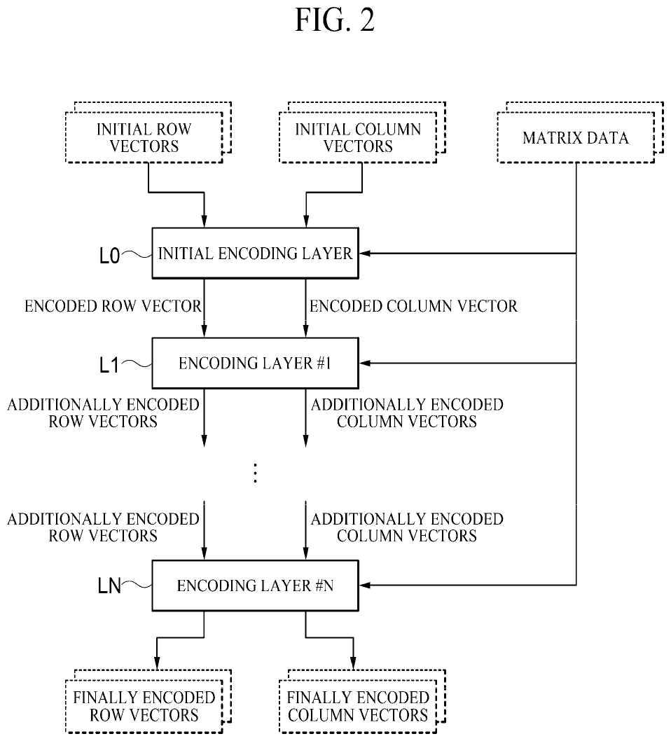

FIG. 2 is a diagram schematically illustrating a matrix data encoding process according to a first embodiment.

As shown, the matrix data encoding apparatus 100 according to the first embodiment may include an initial encoding layer L0 and one or more first encoding layers L1, . . . , LN.

Each of the first type encoding layers L1, . . . , LN may perform additional encoding by using one or more pieces of matrix data representing information on the relationship between items having a plurality of characteristics, a plurality of row vectors output from the immediately preceding encoding layer, and a plurality of column vectors output from the immediately preceding encoding layer as inputs.

That is, each of the first type encoding layers L1, . . . , LN is similar to the initial encoding layer L0 in that it uses, as an input, matrix data in addition to a plurality of row vectors and column vectors output from the immediately preceding encoding layer, and accordingly, the detailed structures of the initial encoding layer L0 and the first type encoding layers L1, . . . , LN may be the same or similar.

Meanwhile, in FIG. 2, a total of N+1 encoding layers are illustrated; however, this is for convenience of description, and according to an embodiment, one or more first type encoding layers are additionally disposed after an ‘encoding layer #N’, and in this case, the row vectors and column vectors output from the encoding layer disposed at the end are ‘finally encoded row vectors’ and ‘finally encoded column vectors’, respectively.

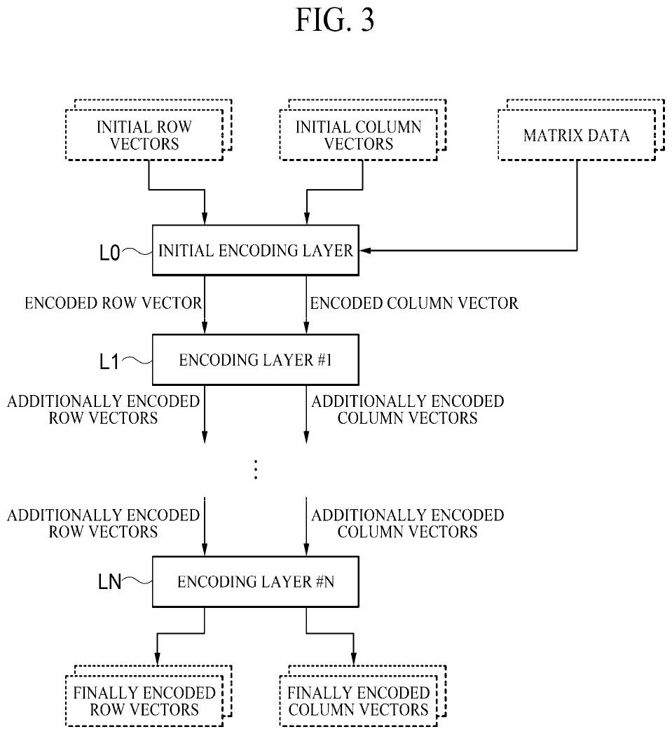

FIG. 3 is a diagram schematically illustrating a matrix data encoding process according to the second embodiment.

As shown, the matrix data encoding apparatus 100 according to the second embodiment may include an initial encoding layer L0 and one or more second type encoding layers L1, . . . , LN. Although the matrix data encoding apparatus 100 is illustrated as not including the first type encoding layer in FIG. 3, this is for convenience of description, and it should be noted that, for each embodiment, the matrix data encoding apparatus 100 may include both the first type encoding layer and the second type encoding layer, each at least one.

Each of the second type encoding layers L1, . . . , LN may perform additional encoding using a plurality of row vectors output from an immediately preceding encoding layer and a plurality of column vectors output from the immediately preceding encoding layer as inputs.

If it is assumed in FIG. 3 that all encoding layers after the initial encoding layer L0 are the second type encoding layers, the matrix data is input only to the initial encoding layer L0 among all encoding layers included in the matrix data encoding apparatus 100. However, since the respective values of the ‘encoded row vectors’ and the ‘encoded column vectors’ output from the initial encoding layer L0 are affected by the matrix data, it is clear that the ‘additionally encoded row vectors’, ‘additionally encoded column vectors’, ‘finally encoded row vectors’ and ‘finally encoded column vectors’ output from subsequent encoding layers L1, . . . , LN are not values independent of the matrix data even if the matrix data is not separately input to subsequent encoding layers L1, . . . , LN.

Meanwhile, in FIG. 3, a total of N+1 encoding layers are illustrated; however, this is for convenience of description, and according to an embodiment, one or more first type encoding layers or second type encoding layers are additionally disposed after an ‘encoding layer #N’, and in this case, the row vectors and column vectors output from the encoding layer disposed at the end are ‘finally encoded row vectors’ and ‘finally encoded column vectors’, respectively.

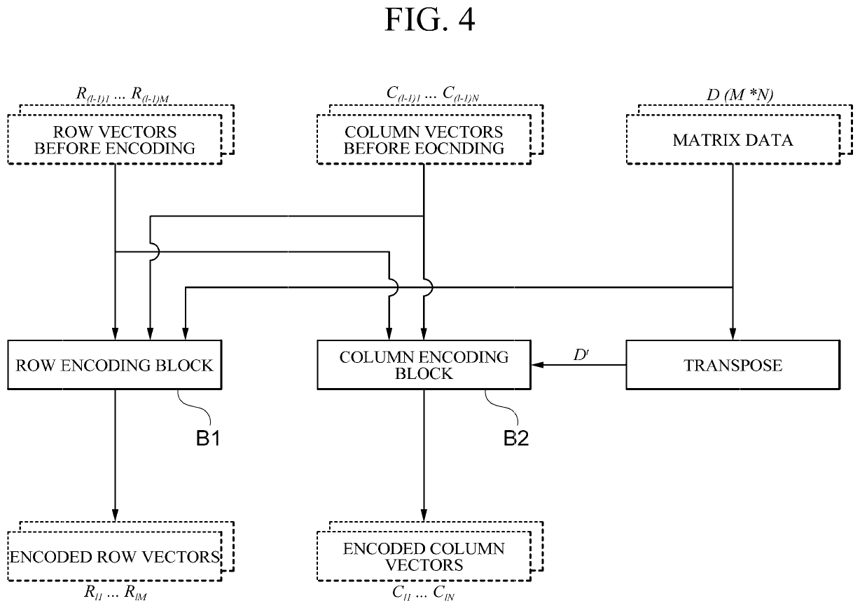

FIGS. 4 to 6 are diagrams illustrating a matrix data encoding process performed in each of first type encoding layers.

Specifically, in the first type encoding layer, various data for matrix data encoding may be transmitted through various paths, and FIGS. 4 to 6 each illustrate an embodiment in which data transmission paths are different.

Each of the first type encoding layers illustrated in FIGS. 4 to 6 are an l−1-th first type encoding layer, and outputs a plurality of row vectors R₁₁, . . . , R_{1M} and a plurality of column vectors C₁₁, . . . C_{1N} by receiving a plurality of row vectors R₍ₗ₋₁₎₁, . . . , R_{(l-1)M} and a plurality of column vectors C₍ₗ₋₁₎₁, . . . , C_{(l-1)N}, which are output from an l−2-th first type encoding layer, and a plurality of pieces of matrix data D(M*N) having a size of M*N, and performing additional encoding. In this case, the prefixes of the row vector and column vector symbol are values corresponding to the sequence number of the input encoding layer, and the prefixes of the initial row vector and column vector symbol are 0. In addition, the subscripts of the row vector and column vector symbol are values corresponding to the sequence number of the corresponding row and column on the matrix data, respectively, and when matrix data having a size of M*N is input, the subscript of the row vector symbol may have a natural number value of 1 or more and M or less, and the subscript of the column vector symbol may have a natural number value of 1 or more and N or less.

Meanwhile, each of the first type encoding layers illustrated in FIGS. 4 to 6 may include a row encoding block B1 and a column encoding block B2.

First, referring to FIG. 4, the row encoding block B1 may output a plurality of additionally encoded row vectors by receiving one or more pieces of matrix data representing information on the relationship between items having a plurality of characteristics, a plurality of row vectors output from the immediately preceding encoding layer, and a plurality of column vectors output from the immediately preceding encoding layer.

At this time, the column encoding block B2 may output a plurality of additionally encoded column vectors by receiving transposed matrix data, the plurality of row vectors output from the immediately preceding encoding layer, and the plurality of column vectors output from the immediately preceding encoding layer.

Specifically, the row encoding block B1 may output the plurality of row vectors R₁₁, . . . , R_{1M} by receiving a plurality of row vectors R₍ₗ₋₁₎₁, . . . , R_{(l-1)M} and the plurality of column vectors C₍ₗ₋₁₎₁, . . . , C_{(l-1)N}, which are output from the l−2-th first type encoding layer, and a plurality of pieces of matrix data D(M*N) having a size of M*N, and the column encoding block B2 may output the plurality of column vectors C₁₁, . . . , C_{1N} by receiving the plurality of row vectors R₍ₗ₋₁₎₁, . . . , R_{(l-1)M} and the plurality of column vectors C₍ₗ₋₁₎₁, . . . , C_{(l-1)N}, which are output from the l−2-th first type encoding layer, and a plurality of transposed matrix data D(N*M).

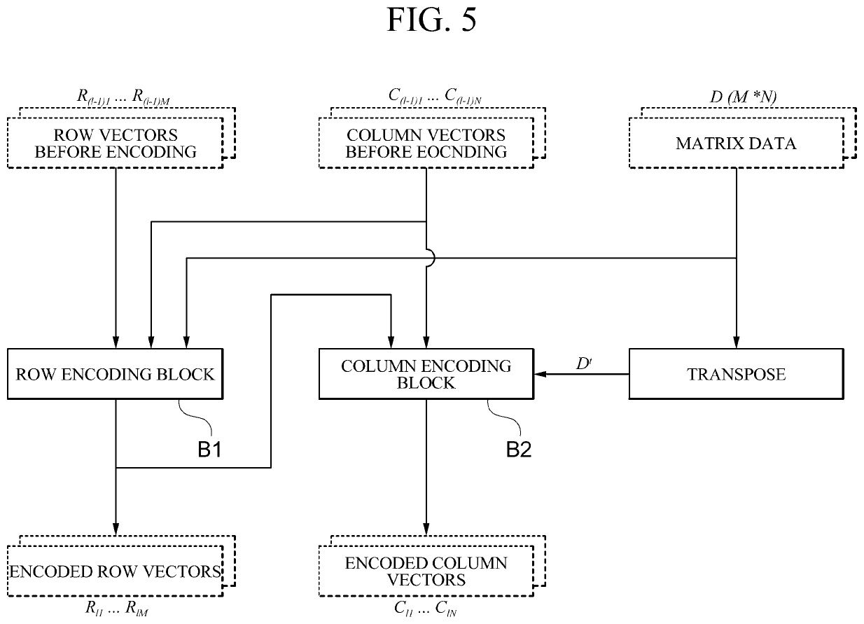

Meanwhile, referring to FIG. 5, the row encoding block B1 may output a plurality of additionally encoded row vectors by receiving one or more pieces of matrix data representing information on the relationship between items having a plurality of characteristics, the plurality of row vectors output from the immediately preceding encoding layer, and the plurality of column vectors output from the immediately preceding encoding layer.

In this case, the column encoding block B2 may output a plurality of additionally encoded column vectors by receiving transposed matrix data, the plurality of additionally encoded row vectors output from the row encoding block B1, and the plurality of column vectors output from the immediately preceding encoding layer.

Specifically, the row encoding block B1 may output the plurality of row vectors R₁₁, . . . , R_{1M} by receiving the plurality of row vectors R₍ₗ₋₁₎₁, . . . , R_{(l-1)M} and the plurality of column vectors C₍ₗ₋₁₎₁, . . . , C_{(l-1)N}, which are output from the l−2-th first type encoding layer, and the plurality of pieces of matrix data D(M*N) having a size of M*N, and the column encoding block B2 may output the plurality of column vectors C₁₁, . . . , C_{1N} by receiving the plurality of row vectors R₁₁, . . . , R_{1M}, output from the row encoding block B1, a plurality of column vectors C₍ₗ₋₁₎₁, . . . , C_{(l-1)N} output from the l−2-th first type encoding layer, and the plurality of transposed matrix data D(N*M).

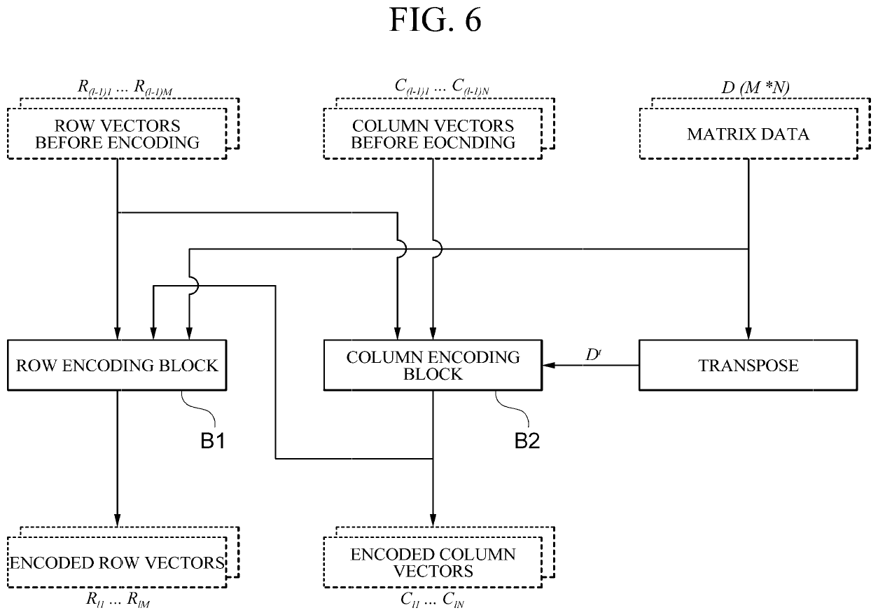

Meanwhile, referring to FIG. 6, the row encoding block B1 may output a plurality of additionally encoded row vectors by receiving one or more pieces of matrix data representing information on the relationship between items having a plurality of characteristics, the plurality of row vectors output from the immediately preceding encoding layer, and the plurality of additionally encoded column vectors output from the column encoding block B2.

In this case, the column encoding block B2 may output a plurality of additionally encoded column vectors by receiving transposed matrix data, the plurality of row vectors output from the immediately preceding encoding layer, and the plurality of column vectors output from the immediately preceding encoding layer.

Specifically, the row encoding block B1 may output the plurality of row vectors by receiving the plurality of row vectors R₍ₗ₋₁₎₁, . . . , R_{(l-1)M} output from the l−2-th first type encoding layer, the plurality of column vectors C₍ₗ₋₁₎₁, . . . , C_{(l-1)N} output from the column encoding block B2, and the plurality of pieces of matrix data D(M*N) having the size of M*N, and the column encoding block B2 may output a plurality of column vectors C₁₁, . . . , C_{1N} by receiving the plurality of row vectors R₍ₗ₋₁₎₁, . . . , R_{(l-1)M} and the plurality of column vectors C₍ₗ₋₁₎₁, . . . , C_{(l-1)N}, which are output from the l−2-th first type encoding layer, and a plurality of transposed matrix data D(N*M).

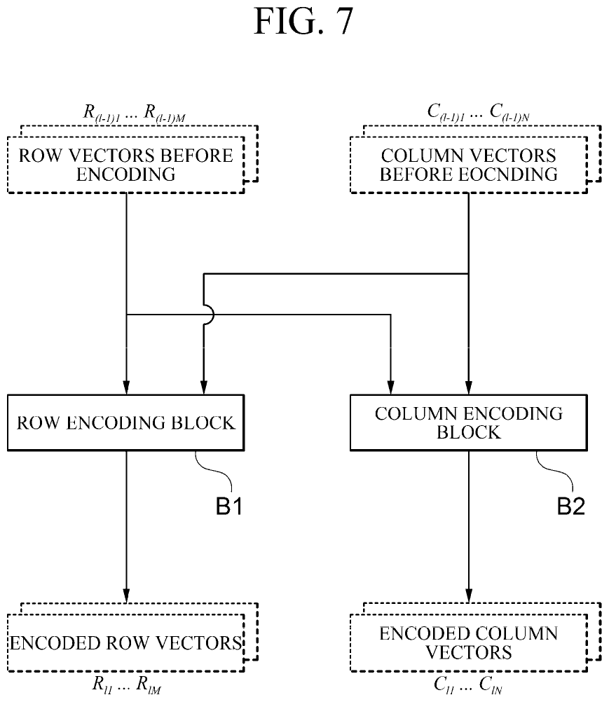

FIGS. 7 to 9 are diagrams illustrating a matrix data encoding process performed in each of second type encoding layers.

Specifically, in the second type encoding layer, various data for matrix data encoding may be transmitted through various paths, and FIGS. 7 to 9 each illustrate an embodiment in which data transmission paths are different.

Each of the second type encoding layers illustrated in FIGS. 7 to 9 are an l−1-th encoding layer after the initial encoding layer L0, and outputs a plurality of row vectors R₁₁, . . . , R_{1M} and a plurality of column vectors by receiving a plurality of row vectors R₍ₗ₋₁₎₁, . . . , R_{(l-1)M} and a plurality of column vectors C₍ₗ₋₁₎₁, . . . , C_{(l-1)N}, which are output from the l−1-th encoding layer after the initial encoding layer L0 and performing additional encoding.

In this case, the prefixes of the row vector and column vector symbol are values corresponding to the sequence number of the input encoding layer, and the prefixes of the initial row vector and column vector symbol are 0. In addition, the subscripts of the row vector and column vector symbol are values corresponding to the sequence number of the corresponding row and column on the matrix data, respectively, and when matrix data having a size of M*N is input to the initial encoding layer L0, the subscript of the row vector symbol may have a natural number value of 1 or more and M or less, and the subscript of the column vector symbol may have a natural number value of 1 or more and N or less.

Meanwhile, each of the second type encoding layers illustrated in FIGS. 7 to 9 may include a row encoding block B1 and a column encoding block B2.

First, referring to FIG. 7, the row encoding block B1 may output a plurality of additionally encoded row vectors based on a plurality of row vectors output from an immediately preceding encoding layer and a plurality of column vectors output from the immediately preceding encoding layer.

In this case, the column encoding block B2 may output a plurality of additionally encoded column vectors based on the plurality of row vectors output from the immediately preceding encoding layer and the plurality of column vectors output from the immediately preceding encoding layer.

Specifically, the row encoding block B1 may output a plurality of row vectors by receiving the plurality of row vectors R₍ₗ₋₁₎₁, . . . , R_{(l-1)M} and the plurality of column vectors C₍ₗ₋₁₎₁, . . . , C_{(l-1)N}, which are output from the l−2-th encoding layer after the initial encoding layer L0, and the column encoding block B2 may output the plurality of column vectors C₁₁, . . . , C_{1N} by receiving the plurality of row vectors R₍ₗ₋₁₎₁, . . . , R_{(l-1)M} and the plurality of column vectors C₍ₗ₋₁₎₁, . . . , C_{(l-1)N}, which are output from the l−2-th encoding layer after initial encoding layer L0.

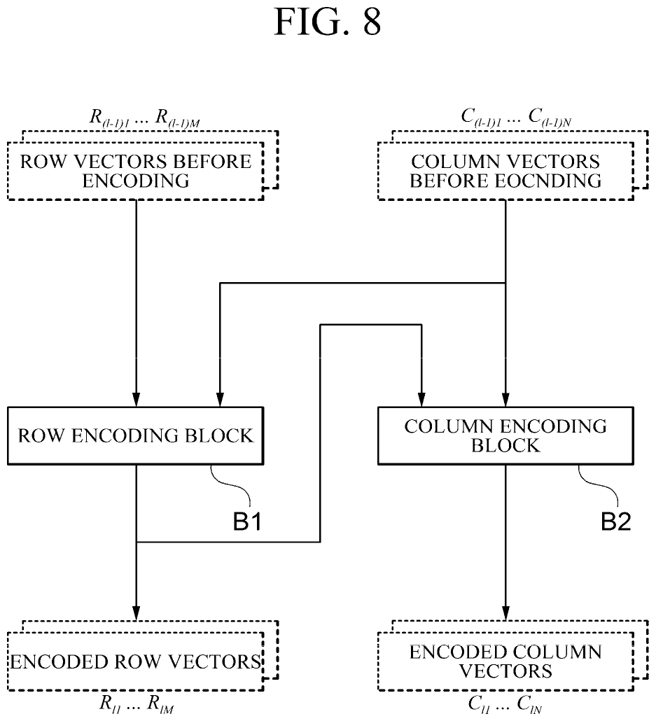

Meanwhile, referring to FIG. 8, the row encoding block B1 may output a plurality of additionally encoded row vectors by receiving the plurality of row vectors output from the immediately preceding encoding layer and the plurality of column vectors output from the immediately preceding encoding layer.

In this case, the column encoding block B2 may output a plurality of additionally encoded column vectors by receiving the plurality of additionally encoded row vectors output from the row encoding block B1, and the plurality of column vectors output from the immediately preceding encoding layer.

Specifically, the row encoding block B1 may output the plurality of row vectors by receiving the plurality of row vectors R₍ₗ₋₁₎₁, . . . , R_{(l-1)M} and the plurality of column vectors C₍ₗ₋₁₎₁, . . . , C_{(l-1)N}, which are output from the l−2-th encoding layer after the initial encoding layer L0, and the column encoding block B2 may output the plurality of column vectors C₁₁, . . . , C_{1N} by receiving the plurality of row vectors Rim output from the row encoding block B1, and a plurality of column vectors C₍ₗ₋₁₎₁, . . . , C_{(l-1)N} output from the l−2-th encoding layer after the initial encoding layer L0.

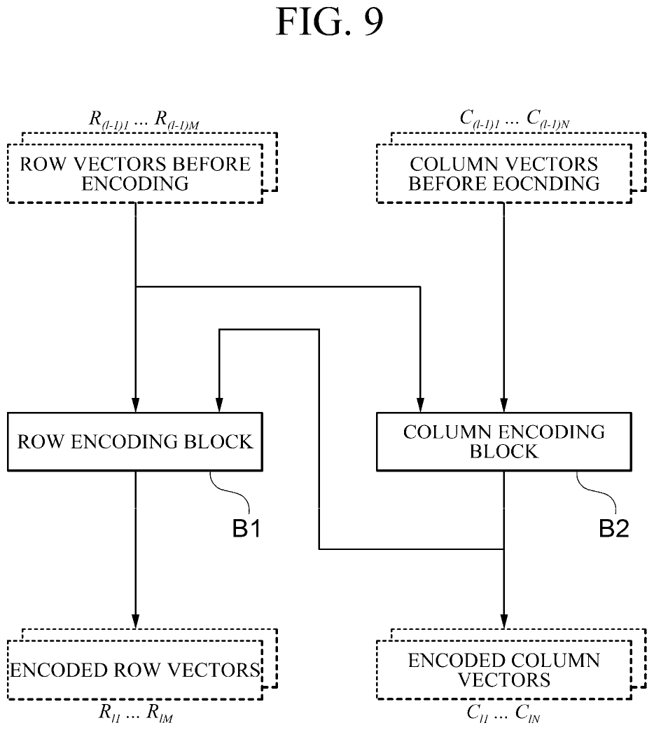

Meanwhile, referring to FIG. 9, the row encoding block B1 may output a plurality of additionally encoded row vectors by receiving the plurality of row vectors output from the immediately preceding encoding layer and the plurality of additionally encoded column vectors output from the column encoding block B2.

In this case, the column encoding block B2 may output a plurality of additionally encoded column vectors by receiving the plurality of row vectors output from the immediately preceding encoding layer and the plurality of column vectors output from the immediately preceding encoding layer.

Specifically, the row encoding block B1 may output the plurality of row vectors by receiving the plurality of row vectors R₍ₗ₋₁₎₁, . . . , R_{(l-1)M} output from the l−2-th encoding layer after the initial encoding layer L0 and the plurality of column vectors output from the column encoding block B2, and the column encoding block B2 may output the plurality of column vectors C₁₁, . . . , C_{1N} by receiving the plurality of row vectors R₍ₗ₋₁₎₁, . . . , R_{(l-1)M} and the plurality of column vectors C₍ₗ₋₁₎₁, . . . , C_{(l-1)N}, which are output from the l−2-th encoding layer after initial encoding layer L0.

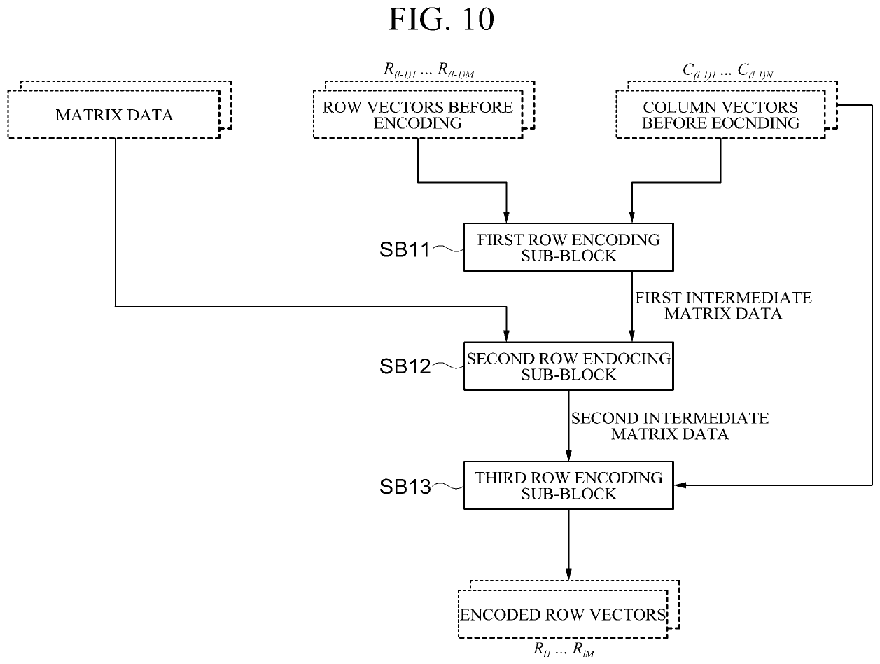

FIG. 10 is a diagram illustrating a matrix data encoding process performed in each row encoding block in a first type encoding layer.

Row encoding blocks shown in FIG. 10 is row encoding blocks in the l−1-th first type encoding layer, and the ‘row vectors before encoding’ and ‘column vectors before encoding’ shown at the top refer to a plurality of row vectors R₍ₗ₋₁₎₁, . . . , R_{(l-1)M} and a plurality of column vectors C₍ₗ₋₁₎₁, . . . , C_{(l-1)N}, which are output from the l−2-th first type encoding layer, respectively. In this case, the subscripts of the row vector and column vector symbols are as described above with reference to FIGS. 4 to 9.

Meanwhile, as shown, each of the row encoding blocks in the first type encoding layer may include a first row encoding sub-block SB11, a second row encoding sub-block SB12, and a third row encoding sub-block SB13.

First, the first row encoding sub-block SB11 may output first intermediate matrix data having the same dimension as matrix data input to the first type encoding layer based on one or more preset functions using a plurality of received row vectors and a plurality of received column vectors as variables.

Specifically, a preset function used in the first row encoding sub-block SB11 is a function for analyzing the relationship between the plurality of row vectors R₍ₗ₋₁₎₁, . . . , R_{(l-1)M} and the plurality of column vectors C₍ₗ₋₁₎₁, . . . , C_{(l-1)N}, which are output from the l−2-th first type encoding layer, and may be a function in which operations such as MatMul and Scale are mixed, for example. However, it should be noted that various functions may be used in the first row encoding sub-block SB11 as long as the input/output form is satisfied in addition to the functions exemplified above.

According to an embodiment, the first row encoding sub-block SB11 may include a self-attention-based network structure. In more detail, the first row encoding sub-block SB11 may include a transformer-based network structure.

Meanwhile, the second row encoding sub-block SB12 may perform element-wise operation on the matrix data input to the first type encoding layer and the first intermediate matrix data based on a learnable neural network to output second intermediate matrix data having the same dimension as the matrix data input to the first type encoding layer.

Specifically, the second row encoding sub-block SB12 may receive the matrix data having a size of M*N and the first intermediate matrix data having a size of M*N, and may perform the element-wise operation using elements located in the same rows and columns of the respective matrixes as inputs of the preset operation.

At this time, when there are a plurality of pieces of matrix data (e.g., matrix #1, matrix #2, . . . , matrix #D), the second row encoding sub-block SB12 may perform the element-wise operation using all of respective elements of the first intermediate matrix data, elements at corresponding positions in matrix #1, elements at corresponding positions in matrix #2, . . . , and elements of corresponding positions in the matrix #D as inputs of the preset operation. In this case, for example, the second row encoding sub-block SB12 may output an element of the first row and the first column of the second intermediate matrix data using all of an element of the first row and the first column of the first intermediate matrix data, an element of the first row and the first column of matrix #1, an element of the first row and the first column of matrix #2, . . . , and an element of the first row and the first column of matrix #D as inputs.

According to an embodiment, the second row encoding sub-block SB12 may perform the above-described element-wise operation based on a neural network including a learnable fully-connected layer and an activation function.

For example, the second row encoding sub-block SB12 may include a neural network structure in which a concatenation layer is disposed at the front end, and learnable fully-connected layers and activation functions are alternately disposed at the rear end. In this case, the second row encoding sub-block SB12 may output each of element values of the second intermediate matrix data by concatenating the matrix data input to the first type encoding layer and the first intermediate matrix data for each element and passing the concatenated vectors through the neural network structure in which the fully connected layers and activation functions are alternately disposed.

Meanwhile, for example, the second row encoding sub-block SB12 may use the ReLU function as an activation function, but is not limited thereto.

Meanwhile, the third row encoding sub-block SB13 may output a plurality of additionally encoded row vectors based on one or more preset functions using the second intermediate matrix data and the plurality of received column vectors as variables.

Specifically, the preset function used in the third row encoding sub-block SB13 is a function for outputting a plurality of row vectors R₁₁, . . . , R_{1M} by receiving the second intermediate matrix data having the size of M*N and the plurality of column vectors C₍ₗ₋₁₎₁, . . . , C_{(l-1)N}, and may be a function in which operations such as Softmax and MatMul are mixed, for example. However, it should be noted that various functions may be used in the third row encoding sub-block SB13 as long as the input/output form is satisfied in addition to the functions exemplified above.

According to an embodiment, the third row encoding sub-block SB13 may include a self-attention-based network structure. In more detail, the third row encoding sub-block SB13 may include a transformer-based network structure.

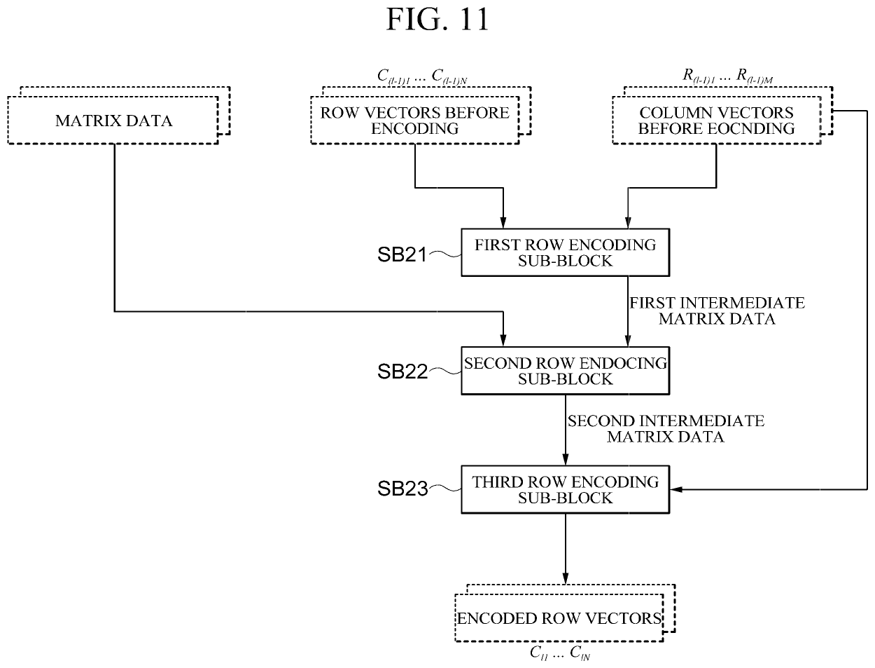

FIG. 11 is a diagram illustrating a matrix data encoding process performed in each column encoding block in a first type encoding layer.

Column encoding blocks shown in FIG. 11 is column encoding blocks in the l−1-th first type encoding layer, and the ‘row vectors before encoding’ and ‘column vectors before encoding’ shown at the top refer to the plurality of row vectors R₍ₗ₋₁₎₁, . . . , R_{(l-1)M} and the plurality of column vectors C₍ₗ₋₁₎₁, . . . , C_{(l-1)N}, which are output from the l−2-th first type encoding layer, respectively. In this case, the subscripts of the row vector and column vector symbols are as described above with reference to FIGS. 4 to 9.

Meanwhile, as shown, each of the column encoding blocks in the first type encoding layer may include a first column encoding sub-block SB21, a second column encoding sub-block SB22, and a third column encoding sub-block SB23.

First, the first column encoding sub-block SB21 may output first intermediate matrix data having the same dimension as matrix data input to the first type encoding layer based on one or more preset functions using the plurality of received row vectors and the plurality of received column vectors as variables.

Specifically, a preset function used in the first column encoding sub-block SB21 is a function for analyzing the relationship between the plurality of row vectors R₍ₗ₋₁₎₁, . . . , R_{(l-1)M} and the plurality of column vectors C₍ₗ₋₁₎₁, . . . , C_{(l-1)N}, which are output from the l−2-th first type encoding layer, and may be a function in which operations such as MatMul and Scale are mixed, for example. However, it should be noted that various functions may be used in the first column encoding sub-block SB21 as long as the input/output form is satisfied in addition to the functions exemplified above.

According to an embodiment, the first column encoding sub-block SB21 may include a self-attention-based network structure. In more detail, the first column encoding sub-block SB21 may include a transformer-based network structure.

Meanwhile, the second column encoding sub-block SB22 may perform element-wise operation on the matrix data input to the first type encoding layer and the first intermediate matrix data based on a learnable neural network to output second intermediate matrix data having the same dimension as the matrix data input to the first type encoding layer.

Specifically, the second column encoding sub-block SB22 may receive the matrix data having a size of M*N and the first intermediate matrix data having a size of M*N, and may perform the element-wise operation using elements located in the same rows and columns of the respective matrixes as inputs of the preset operation.

At this time, when there are a plurality of pieces of matrix data (e.g., matrix #1, matrix #2, . . . , matrix #D), the second column encoding sub-block SB22 may perform the element-wise operation using all of respective elements of the first intermediate matrix data, elements at corresponding positions in matrix #1, elements at corresponding positions in matrix #2, . . . , and elements of corresponding positions in the matrix #D as inputs of the preset operation. In this case, for example, the second column encoding sub-block SB22 may output an element of the first row and the first column of the second intermediate matrix data using all of an element of the first row and the first column of the first intermediate matrix data, an element of the first row and the first column of matrix #1, an element of the first row and the first column of matrix #2, . . . , and an element of the first row and the first column of matrix #D as inputs.

According to an embodiment, the second column encoding sub-block SB22 may perform the above-described the element-wise operation based on a neural network including a learnable fully-connected layer and an activation function.

For example, the second column encoding sub-block SB22 may include a neural network structure in which a concatenation layer is disposed at the front end, and learnable fully-connected layers and activation functions are alternately disposed at the rear end. In this case, the second column encoding sub-block SB22 may output each of element values of the second intermediate matrix data by concatenating the matrix data input to the first type encoding layer and the first intermediate matrix data for each element and passing the concatenated vectors through the neural network structure in which the fully connected layers and activation functions are alternately disposed.

Meanwhile, for example, the second column encoding sub-block SB22 may use the ReLU function as an activation function, but is not limited thereto.

Meanwhile, the third column encoding sub-block SB23 may output a plurality of additionally encoded column vectors based on one or more preset functions using the second intermediate matrix data and the plurality of received row vectors as variables.

Specifically, the preset function used in the third column encoding sub-block SB23 is a function for outputting a plurality of row vectors C₁₁, . . . , C_{1M} by receiving the second intermediate matrix data having the size of M*N and the plurality of row vectors R₍ₗ₋₁₎₁, . . . , R_{(l-1)N}, and may be a function in which operations such as Softmax and MatMul are mixed, for example. However, it should be noted that various functions may be used in the third column encoding sub-block SB23 as long as the input/output form is satisfied in addition to the functions exemplified above.

According to an embodiment, the third column encoding sub-block SB23 may include a self-attention-based network structure. In more detail, the third column encoding sub-block SB23 may include a transformer-based network structure.

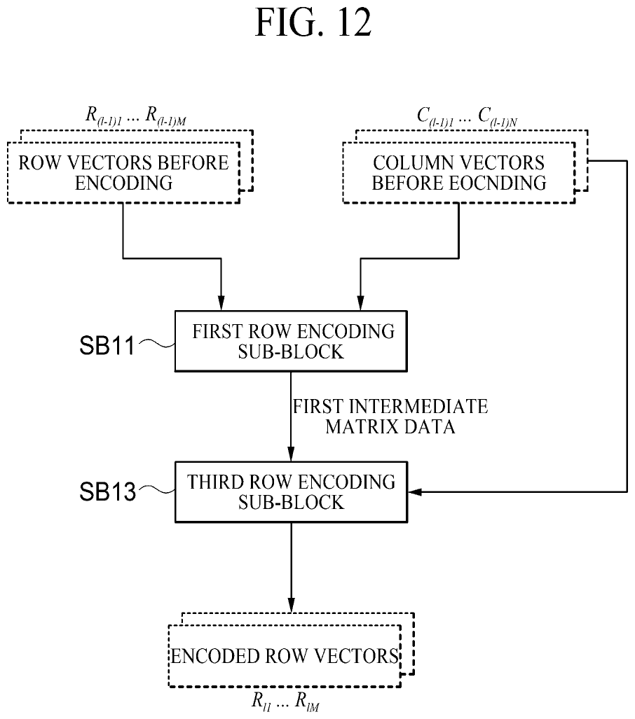

FIG. 12 is a diagram illustrating a matrix data encoding process performed in each row encoding block in a second type encoding layer.

Row encoding blocks shown in FIG. 12 is row encoding blocks in the second type encoding layer, which is the l−1-th encoding layer after the initial encoding layer L0, and the ‘row vectors before encoding’ and ‘column vectors before encoding’ shown at the top refer to a plurality of row vectors R₍ₗ₋₁₎₁, . . . , R_{(l-1)M} and a plurality of column vectors C₍ₗ₋₁₎₁, . . . , C_{(l-1)N}, which are output from the l−2-th encoding layer after the first encoding layer L0, respectively. In this case, the subscripts of the row vector and column vector symbols are as described above with reference to FIGS. 4 to 9.

Meanwhile, as shown, each of the row encoding blocks in the second type encoding layer may include a first row encoding sub-block SB11 and a third row encoding sub-block SB13.

First, the first row encoding sub-block SB11 may output first intermediate matrix data having the same dimension as matrix data input to the initial encoding layer L0 based on one or more preset functions using a plurality of received row vectors and a plurality of received column vectors as variables.

Meanwhile, the third row encoding sub-block SB13 may output a plurality of additionally encoded row vectors based on one or more preset functions using the first intermediate matrix data and the plurality of received column vectors as variables.

Details related to the first row encoding sub-block SB11 and the third row encoding sub-block SB13 are the same as or similar to those described above with reference to FIG. 10, and thus repeated descriptions thereof will be omitted.

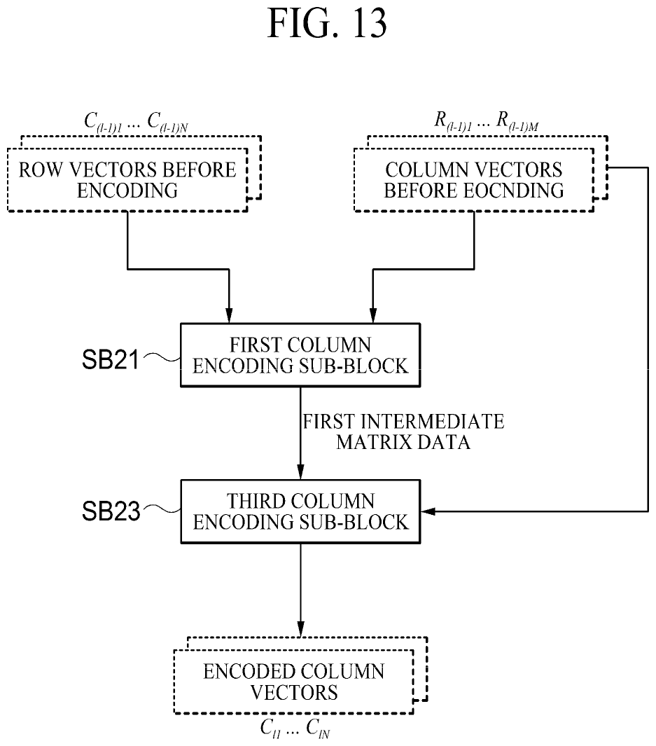

FIG. 13 is a diagram illustrating a matrix data encoding process performed in each column encoding block in a second type encoding layer.

Column encoding blocks shown in FIG. 13 is column encoding blocks in the second type encoding layer, which is the l−1-th encoding layer after the initial encoding layer L0, and the ‘row vectors before encoding’ and ‘column vectors before encoding’ shown at the top refer to a plurality of row vectors R₍ₗ₋₁₎₁, . . . , R_{(l-1)M} and a plurality of column vectors C₍ₗ₋₁₎₁, . . . , C_{(l-1)N}, which are output from the l−2-th encoding layer after the first encoding layer L0, respectively. In this case, the subscripts of the row vector and column vector symbols are as described above with reference to FIGS. 4 to 9.

Meanwhile, as shown, each of the column encoding blocks in the second type encoding layer may include a first column encoding sub-block SB21 and a third column encoding sub-block SB23.

First, the first column encoding sub-block SB21 may output first intermediate matrix data having the same dimension as matrix data input to the initial encoding layer L0 based on one or more preset functions using a plurality of received row vectors and a plurality of received column vectors as variables.

Meanwhile, the third column encoding sub-block SB23 may output a plurality of additionally encoded column vectors based on one or more preset functions using the first intermediate matrix data and the plurality of received row vectors as variables.

Details related to the first column encoding sub-block SB21 and the third column encoding sub-block SB23 are the same as or similar to those described above with reference to FIG. 11, and thus repeated descriptions thereof will be omitted.

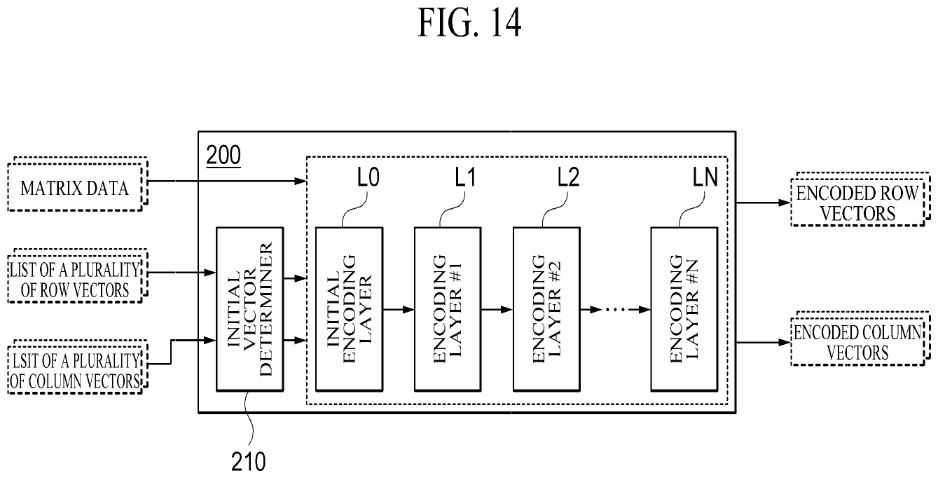

FIG. 14 is a block diagram for illustrating a matrix data encoding apparatus 200 according to an additional embodiment.

Referring to FIG. 14, the matrix data encoding apparatus 200 according to an additional embodiment may further include an initial vector determiner 210, in addition of an initial encoding layer L0 and one or more encoding layers L1, L2, . . . , LN. The initial encoding layer L0 and one or more encoding layers L1, L2, . . . , LN shown in FIG. 14 perform the same or similar functions as those described with reference to FIG. 1, and thus repeated descriptions thereof will be omitted.

In the illustrated embodiment, each component may have different functions and capabilities in addition to those described below, and additional components may be included in addition to those described below.

In addition, in an embodiment, each encoding layer may be implemented by using one or more physically separated devices, or may be implemented by one or more processors or a combination of one or more processors and software, and may not be clearly distinguished in specific operations, unlike the illustrated example.

The initial vector determiner 210 determines row vectors and column vectors to be input to the initial encoding layer L0 by receiving a row vector list composed of a plurality of row vectors and a column vector list composed of a plurality of column vectors.

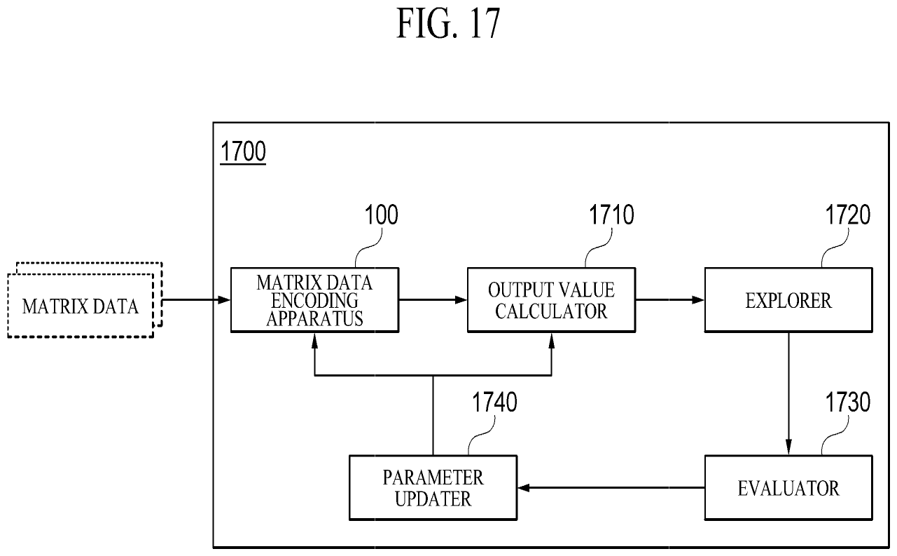

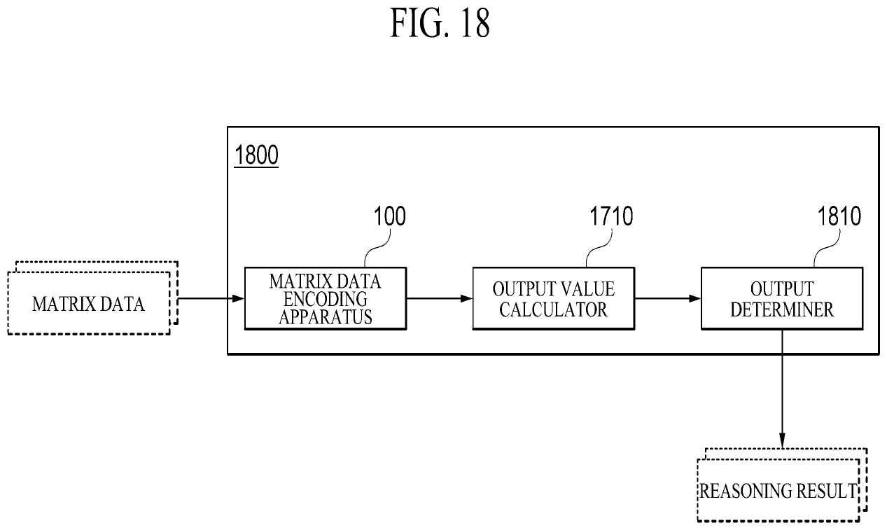

Specifically, since M initial row vectors and N initial column vectors are required when encoding is performed on matrix data having an original size of M*N, the initial vector determiner 210 determines M initial row vectors from among row vectors included in the row vector list or determines N initial column vectors from among column vectors included in the column vector list, which makes it possible to diversify the initial row vectors or initial column vectors as compared with a case where M initial row vectors and N initial column vectors are fixed in advance. For this reason, the matrix data encoding apparatus 200 may output more various encoding results even when the same matrix data is input, and thus learning performance and reasoning performance may be improved in a learning and reasoning process to be described later with reference to FIGS. 17 and 18.

According to an embodiment, the initial vector determiner 210 may concurrently determine the plurality of initial row vectors and the plurality of initial column vectors; however, if a zero vector is used for the plurality of initial row vectors or the plurality of initial column vectors, the initial vector determiner 210 may determine only the other vectors other than the zero vector. For example, when a zero vector is used for the plurality of initial row vectors for encoding of matrix data, the initial vector determiner 210 may determine only the plurality of initial column vectors.

According to an embodiment, the initial vector determiner 210 may determine at least some of the plurality of initial row vectors and the plurality of initial column vectors based on at least one of a first technique for randomly selecting as many vectors as the number corresponding to the number of rows or columns of the matrix data from a list of a plurality of Vectors Prepared in Advance and a Second Technique for Randomly Sorting as Many Vectors as the number corresponding to the number of rows or columns of the matrix data. The first technique and the second technique will be described in detail as follows.

(1) First Technique In order to encode matrix data having a size of M*N, M row vectors are randomly selected from a row vector list containing R(>=M) row vectors prepared in advance, and N column vectors are randomly selected from a column vector list containing S(>=N) column vectors prepared in advance.

In this case, when the dimensions of the row vector and the column vector are the same, M row vectors and N column vectors may be randomly selected from a vector list Containing M or More and N or More Vectors.

(2) Second Technique

In order to encode matrix data having a size M*N, vectors in the list of M row vectors are arbitrarily sorted by the number of M! and used as the input of the initial encoding layer L0, and vectors in the list of N column vectors are arbitrarily sorted by the number of N! and used as the input of the initial encoding layer L0.

In this way, by shuffling the order between the vectors corresponding to the number of rows or columns of matrix data, an effect similar to that of shuffling rows or columns of matrix data may be derived.

Meanwhile, according to another embodiment, the initial vector determiner 210 may determine initial row vectors or initial column vectors by selecting vectors according to a preset selection criterion instead of the first technique of randomly selecting vectors to be input to the initial encoding layer L0.

Further, according to another embodiment, the initial vector determiner 210 may determine initial row vectors or initial column vectors by sorting vectors according to a preset sorting criterion instead of the second technique of randomly sorting as many vectors as the number corresponding to the rows or columns of the matrix data.

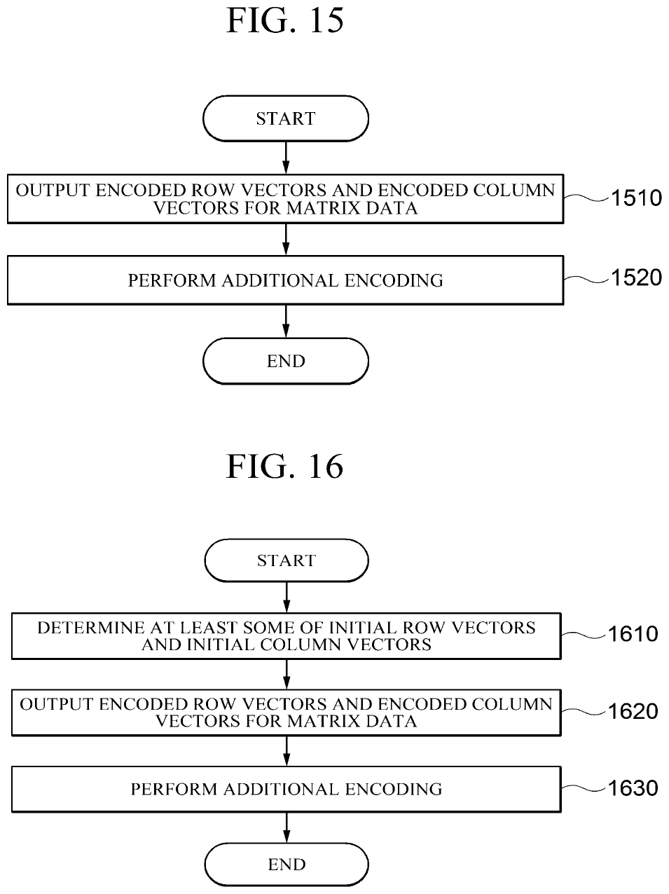

FIG. 15 is a flowchart illustrating a method for encoding matrix data according to an embodiment.

The method shown in FIG. 15 may be performed by, for example, the matrix data encoding apparatus 100 described above with reference to FIG. 1.

First, the matrix data encoding apparatus 100 outputs a plurality of encoded row vectors and a plurality of encoded column vectors for one or more pieces of matrix data representing information on a relationship between items having a plurality of characteristics based on the matrix data, a plurality of initial row vectors corresponding to the number of rows of the matrix data, and a plurality of initial column vectors corresponding to the number of columns of the matrix data (1510).

Then, the matrix data encoding apparatus 100 performs additional encoding on the plurality of encoded row vectors and the plurality of encoded column vectors (1520).

FIG. 16 is a flowchart illustrating a method for encoding matrix data according to an additional embodiment.

The method shown in FIG. 16 may be performed by, for example, the matrix data encoding apparatus 200 described above with reference to FIG. 4.

First, the matrix data encoding apparatus 200 determines at least some of the plurality of initial row vectors and the plurality of initial column vectors based on at least one of a first technique for randomly selecting as many vectors as the number corresponding to the number of rows or columns of one or more pieces of matrix data representing information on a relationship between items having a plurality of characteristics from a list of a plurality of vectors prepared in advance and a second technique for randomly sorting as many vectors as the number corresponding to the number of rows or columns of the matrix data (1610).

Then, the matrix data encoding apparatus 200 outputs a plurality of encoded row vectors and a plurality of encoded column vectors for the matrix data based on the matrix data, a plurality of initial row vectors corresponding to the number of rows of the matrix data, and a plurality of initial column vectors corresponding to the number of columns of the matrix data (1620).

Then, the matrix data encoding apparatus 200 performs additional encoding on the plurality of encoded row vectors and the plurality of encoded column vectors (1630).

In the illustrated flowcharts in FIGS. 15 and 16, the method is divided into a plurality of steps; however, at least some of the steps may be performed in a different order, performed together in combination with other steps, omitted, performed in subdivided steps, or performed by adding one or more steps not illustrated.

FIG. 17 is a block diagram for illustrating an exemplary combinatorial optimization learning apparatus 1700 including the matrix data encoding apparatus 100 according to an embodiment.

Referring to FIG. 17, one or more pieces of matrix data representing information on a relationship between items having a plurality of characteristics are input to the matrix data encoding apparatus 100.

Then, the matrix data encoding apparatus 100 performs encoding on the received matrix data, outputs a plurality of encoded row vectors and column vectors, and transmits output vectors to an output value calculator 1710.

Then, the output value calculator 1710 calculates a value according to each combination when the combination (action) is taken based on a plurality of transmitted encoded row vectors and column vectors. For example, when the output value calculator 1710 is a model based on Q-learning, the output value calculator 1710 calculates an obtainable value when each combination is selected, and when the output value calculator 1710 is a model based on a policy gradient, the output value calculator 1710 calculates the probability of receiving a positive evaluation when each combination is selected.

Then, an explorer 1720 outputs an exploration result according to an exploration policy based on the output of the output value calculator 1710, and an evaluator 1730 evaluates the exploration result output from the explorer 1720.

Then, a parameter updater 1740 updates parameters of the matrix data encoding apparatus 100 and the output value calculator 1710 based on the evaluation result of the evaluator 1730. Specifically, in the matrix data encoding apparatus 100, parameters of sub-blocks included in each row encoding block and each column encoding block may be updated. Alternatively, parameters of a learning model that generates initial row vectors and initial column vectors may be updated. Alternatively, parameters of the initial vector determiner 210 may be updated.

In the above-described embodiment of FIG. 17, data transmission between the components may be achieved through a communication network, where the communication network may include the Internet, one or more local area networks, wide area networks, cellular networks, mobile networks, other types of networks, or a combination of the above networks.

FIG. 18 is a block diagram for illustrating an exemplary combinatorial optimization inference apparatus 1800 including the matrix data encoding apparatus 100 according to an embodiment.

Referring to FIG. 18, one or more pieces of matrix data representing information on a relationship between items having a plurality of characteristics are input to the matrix data encoding apparatus 100.

Then, the matrix data encoding apparatus 100 performs encoding on the received matrix data, outputs a plurality of encoded row vectors and column vectors, and transmits output vectors to an output value calculator 1710.

Then, the output value calculator 1710 calculates a value according to each combination when the combination is taken based on a plurality of transmitted encoded row vectors and column vectors. For example, when the output value calculator 1710 is a model based on Q-learning, the output value calculator 1710 calculates an obtainable value when each combination is selected, and when the output value calculator 1710 is a model based on a policy gradient, the output value calculator 1710 calculates the probability of receiving a positive evaluation when each combination is selected.

Then, the output determiner 1810 reasons out an optimal combination (reasoning result) according to the input matrix data based on the output of the output value calculator 1710.

In the above-described embodiment of FIG. 18, data transmission between the components may be achieved through a communication network, where the communication network may include the Internet, one or more local area networks, wide area networks, cellular networks, mobile networks, other types of networks, or a combination of the above networks.

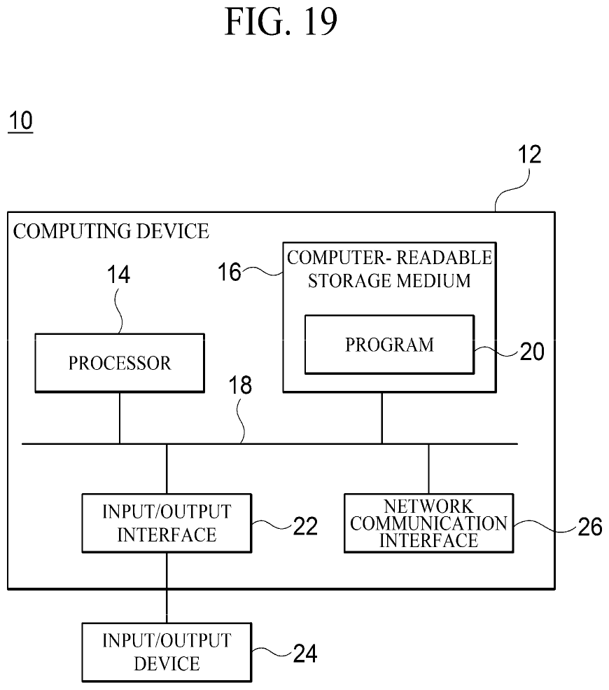

FIG. 19 is a block diagram for exemplarily illustrating a computing environment 10 including a computing device according to an embodiment. In the illustrated embodiment, each component may have different functions and capabilities in addition to those described below, and additional components may be included in addition to those described below.

The illustrated computing environment 10 includes a computing device 12. In the above-described embodiments, the computing device 12 may be the matrix data encoding apparatus 100 according to an embodiment. Furthermore, the computing device 12 may be the matrix data encoding apparatus 200 according to an additional embodiment.

The computing device 12 includes at least one processor 14, a computer-readable storage medium 16, and a communication bus 18. The processor 14 may cause the computing device 12 to operate according to the above-described exemplary embodiments. For example, the processor 14 may execute one or more programs stored in the computer-readable storage medium 16. The one or more programs may include one or more computer-executable instructions, which may be configured to cause, when executed by the processor 14, the computing device 12 to perform operations according to the exemplary embodiments.

The computer-readable storage medium 16 is configured to store computer-executable instructions or program codes, program data, and/or other suitable forms of information. A program 20 stored in the computer-readable storage medium 16 includes a set of instructions executable by the processor 14. In an embodiment, the computer-readable storage medium 16 may be a memory (a volatile memory such as a random-access memory, a non-volatile memory, or any suitable combination thereof), one or more magnetic disk storage devices, optical disc storage devices, flash memory devices, other types of storage media that are accessible by the computing device 12 and may store desired information, or any suitable combination thereof.

The communication bus 18 interconnects various other components of the computing device 12, including the processor 14 and the computer-readable storage medium 16.

The computing device 12 may also include one or more input/output interfaces 22 that provide an interface for one or more input/output devices 24, and one or more network communication interfaces 26. The input/output interface 22 and the network communication interface 26 are connected to the communication bus 18. The input/output device 24 may be connected to other components of the computing device 12 via the input/output interface 22. The exemplary input/output device 24 may include a pointing device (a mouse, a trackpad, or the like), a keyboard, a touch input device (a touch pad, a touch screen, or the like), a voice or sound input device, input devices such as various types of sensor devices and/or imaging devices, and/or output devices such as a display device, a printer, an interlocutor, and/or a network card. The exemplary input/output device 24 may be included inside the computing device 12 as a component constituting the computing device 12, or may be connected to the computing device 12 as a separate device distinct from the computing device 12.

According to the embodiments disclosed herein, a neural network-based structure is presented that performs encoding with vectors representing each row and column for input data in a matrix form, which makes it possible to efficiently search for an optimal combination in a combinatorial optimization problem for data of a two-dimensional structure suitable to be expressed in a matrix form.

Furthermore, according to the embodiments disclosed herein, an initial vector used when input data in the matrix form is encoded is variously determined, which makes it possible to derive a higher performance optimization result even when the same matrix data is input.

Meanwhile, the embodiments of the present invention may include a program for performing the methods described herein on a computer, and a computer-readable recording medium including the program. The computer-readable recording medium may include program instructions, a local data file, a local data structure, or the like alone or in combination. The media may be specially designed and configured for the present disclosure, or may be commonly used in the field of computer software. Examples of computer-readable recording media include magnetic media such as hard disks, floppy disks and magnetic tapes, optical recording media such as a CD-ROM and a DVD, and hardware devices specially configured to store and execute program instructions such as a ROM, a RAM, and a flash memory. Examples of the program may include not only machine language codes such as those produced by a compiler, but also high-level language codes that can be executed by a computer using an interpreter or the like.

Although the representative embodiments of the present disclosure have been described in detail as above, those skilled in the art will understand that various modifications may be made thereto without departing from the scope of the present disclosure. Therefore, the scope of rights of the present disclosure should not be limited to the described embodiments, but should be defined not only by the claims set forth below but also by equivalents of the claims.

What is claimed is:

1. An apparatus for encoding matrix data, the apparatus comprising:
an initial encoding layer configured to output a plurality of encoded row vectors and a plurality of encoded column vectors for one or more pieces of matrix data representing information on a relationship between items having a plurality of characteristics based on the matrix data, a plurality of initial row vectors corresponding to the number of rows of the matrix data, and a plurality of initial column vectors corresponding to the number of columns of the matrix data; and
one or more encoding layers disposed after the initial encoding layer and configured to perform additional encoding on the plurality of encoded row vectors and the plurality of encoded column vectors.

2. The apparatus of claim 1, wherein the one or more encoding layers include a first type encoding layer configured to perform additional encoding using the matrix data, a plurality of row vectors output from an immediately preceding encoding layer, and a plurality of column vectors output from the immediately preceding encoding layer as inputs.

3. The apparatus of claim 1, wherein the one or more encoding layers include a second type encoding layer configured to perform additional encoding using a plurality of row vectors output from an immediately preceding encoding layer and a plurality of column vectors output from the immediately preceding encoding layer as inputs.

4. The apparatus of claim 2, wherein the first type encoding layer includes:
a row encoding block configured to output a plurality of additionally encoded row vectors by receiving the matrix data, the plurality of row vectors output from the immediately preceding encoding layer, and the plurality of column vectors output from the immediately preceding encoding layer; and
a column encoding block configured to output a plurality of additionally encoded column vectors by receiving transposed matrix data, the plurality of row vectors output from the immediately preceding encoding layer, and the plurality of column vectors output from the immediately preceding encoding layer.

5. The apparatus of claim 2, wherein the first type encoding layer includes:
a row encoding block configured to output a plurality of additionally encoded row vectors by receiving the matrix data, the plurality of row vectors output from the immediately preceding encoding layer, and the plurality of column vectors output from the immediately preceding encoding layer; and
a column encoding block configured to output a plurality of additionally encoded column vectors by receiving transposed matrix data, the plurality of additionally encoded row vectors output from the row encoding block, and the plurality of column vectors output from the immediately preceding encoding layer.

6. The apparatus of claim 2, wherein the first type encoding layer includes:
a column encoding block configured to output a plurality of additionally encoded column vectors by receiving transposed matrix data, the plurality of row vectors output from the immediately preceding encoding layer, and the plurality of column vectors output from the immediately preceding encoding layer; and
a row encoding block configured to output a plurality of additionally encoded row vectors by receiving the matrix data, the plurality of row vectors output from the immediately preceding encoding layer, and the plurality of additionally encoded column vectors output from the column encoding block.

7. The apparatus of claim 3, wherein the second type encoding layer includes:
a row encoding block configured to output a plurality of additionally encoded row vectors based on the plurality of row vectors output from the immediately preceding encoding layer and the plurality of column vectors output from the immediately preceding encoding layer; and
a column encoding block configured to output a plurality of additionally encoded column vectors based on the plurality of row vectors output from the immediately preceding encoding layer and the plurality of column vectors output from the immediately preceding encoding layer.

8. The apparatus of claim 3, wherein the second type encoding layer includes:
a row encoding block configured to output a plurality of additionally encoded row vectors by receiving the plurality of row vectors output from the immediately preceding encoding layer and the plurality of column vectors output from the immediately preceding encoding layer; and
a column encoding block configured to output a plurality of additionally encoded column vectors by receiving the plurality of additionally encoded row vectors output from the row encoding block, and the plurality of column vectors output from the immediately preceding encoding layer.

9. The apparatus of claim 3, wherein the second type encoding layer includes:
a column encoding block configured to output a plurality of additionally encoded column vectors by receiving the plurality of row vectors output from the immediately preceding encoding layer and the plurality of column vectors output from the immediately preceding encoding layer; and
a row encoding block configured to output a plurality of additionally encoded row vectors by receiving the plurality of row vectors output from the immediately preceding encoding layer and the plurality of additionally encoded column vectors output from the column encoding block.

10. The apparatus of any one of claim 2,
wherein the first type encoding layer includes: a row encoding block configured to output a plurality of additionally encoded row vectors; and a column encoding block configured to output a plurality of additionally encoded column vectors,
wherein the row encoding block includes:
a first row encoding sub-block configured to output first intermediate matrix data having the same dimension as the matrix data based on one or more preset functions using the plurality of received row vectors and the plurality of received column vectors as variables;
a second row encoding sub-block configured to output second intermediate matrix data having the same dimension as the matrix data by performing element-wise operation on the matrix data and the first intermediate matrix data based on a learnable neural network; and
a third row encoding sub-block configured to output the plurality of additionally encoded row vectors based on one or more preset functions using the second intermediate matrix data and the plurality of received column vectors as variables.

11. The apparatus of any one of claim 2,
wherein the first type encoding layer includes: a row encoding block configured to output a plurality of additionally encoded row vectors; and a column encoding block configured to output a plurality of additionally encoded column vectors,
wherein the column encoding block includes:
a first column encoding sub-block configured to output first intermediate matrix data having the same dimension as the matrix data based on one or more preset functions using the plurality of received row vectors and the plurality of received column vectors as variables;
a second column encoding sub-block configured to output second intermediate matrix data having the same dimension as the matrix data by performing element-wise operation on the matrix data and the first intermediate matrix data based on a learnable neural network; and
a third column encoding sub-block configured to output the plurality of additionally encoded column vectors based on one or more preset functions using the second intermediate matrix data and the plurality of received row vectors as variables.

12. The apparatus of any one of claim 3,
wherein the second type encoding layer includes: a row encoding block configured to output a plurality of additionally encoded row vectors; and a column encoding block configured to output a plurality of additionally encoded column vectors,
wherein the row encoding block includes:
a first row encoding sub-block configured to output first intermediate matrix data having the same dimension as the matrix data based on one or more preset functions using the plurality of received row vectors and the plurality of received column vectors as variables; and
a third row encoding sub-block configured to output the plurality of additionally encoded row vectors based on one or more preset functions using the first intermediate matrix data and the plurality of received column vectors as variables.

13. The apparatus of any one of claim 3,
wherein the second type encoding layer includes: a row encoding block configured to output a plurality of additionally encoded row vectors; and a column encoding block configured to output a plurality of additionally encoded column vectors,
wherein the column encoding block includes:
a first column encoding sub-block configured to output first intermediate matrix data having the same dimension as the matrix data based on one or more preset functions using the plurality of received row vectors and the plurality of received column vectors as variables; and
a third column encoding sub-block configured to output the plurality of additionally encoded column vectors based on one or more preset functions using the first intermediate matrix data and the plurality of received row vectors as variables.

14. The apparatus of claim 1, further comprising an initial vector determiner configured to determine at least some of the plurality of initial row vectors and the plurality of initial column vectors based on at least one of a first technique for randomly selecting as many vectors as the number corresponding to the number of rows or columns of the matrix data from a list of a plurality of vectors prepared in advance and a second technique for randomly sorting as many vectors as the number corresponding to the number of rows or columns of the matrix data.

15. The apparatus of claim 1, wherein the plurality of initial row vectors or the plurality of initial column vectors are zero vectors.

16. A method for encoding matrix data, comprising:
outputting a plurality of encoded row vectors and a plurality of encoded column vectors for one or more pieces of matrix data representing information on a relationship between items having a plurality of characteristics based on the matrix data, a plurality of initial row vectors corresponding to the number of rows of the matrix data, and a plurality of initial column vectors corresponding to the number of columns of the matrix data; and
performing additional encoding on the plurality of encoded row vectors and the plurality of encoded column vectors.

17. The method of claim 16, wherein the performing of the additional encoding includes performing first type encoding of performing additional encoding using the matrix data, a plurality of row vectors output from a result of performing immediately preceding encoding, and a plurality of column vectors output from the result of the performing of the immediately preceding encoding as inputs.

18. The method of claim 16, wherein the performing of the additional encoding includes performing second type encoding of performing additional encoding using a plurality of row vectors output from a result of performing immediately preceding encoding, and a plurality of column vectors output from the result of the performing of the immediately preceding encoding as inputs.

19. The method of claim 17, wherein the performing of the first type encoding includes:
performing row encoding of outputting a plurality of additionally encoded row vectors by receiving the matrix data, the plurality of row vectors output from the result of the performing of the immediately preceding encoding, and the plurality of column vectors output from the result of the performing of the immediately preceding encoding; and
performing column encoding of outputting a plurality of additionally encoded column vectors by receiving transposed matrix data, the plurality of row vectors output from the result of the performing of the immediately preceding encoding, and the plurality of column vectors output from the result of the performing of the immediately preceding encoding.

20. The method of claim 18, wherein the performing of the second type encoding includes:
performing row encoding of outputting a plurality of additionally encoded row vectors based on the plurality of row vectors output from the result of the performing of the immediately preceding encoding and the plurality of column vectors output from the result of the performing of the immediately preceding encoding; and
performing column encoding of outputting a plurality of additionally encoded column vectors based on the plurality of row vectors output from the result of the performing of the immediately preceding encoding, and the plurality of column vectors output from the result of the performing of the immediately preceding encoding.
